(19) United States
(12) Patent Application Publication
(10) Pub. No.: US 2019/0244276 A1
(43) Pub. Date: Aug. 8, 2019

(54) Method and System for Matching Graphics

(71) Applicant: Happy Ray Co. Ltd., Taipei City (TW)

(72) Inventor: Yu-Feng Ko, Taipei City (TW)

(21) Appl. No.: 16/388,923

(22) Filed: Apr. 19, 2019

Related U.S. Application Data
(63) Continuation-in-part of application No. 14/706,183, filed on May 7, 2015.

(30) Foreign Application Priority Data
May 9, 2014 (TW) 103116486

(51) Int. Cl. G06Q 30/06; G06K 9/46

(52) U.S. Cl. CPC G06Q 30/0631; G06Q 30/0643; G06K 9/4609

(57) ABSTRACT

A method for matching graphics for an electronic device includes: receiving a connection of at least one merchant device via a network, wherein the merchant device is connected to a manage platform on the electronic device; receiving a plurality of first secondary object graphics from the merchant device; receiving a connection of at least one user device via a network, wherein the user device is connected to the manage platform on the electronic device; providing the first secondary object graphics for the user device; and when one of the first secondary object graphics is selected, enlarging and fitting the one of the first secondary object graphics on a primary object graphic so that the selected one of the first secondary object graphics enlarged and fitted on the primary object graphic is always larger than all other first secondary object graphics in the first display area.

### CROSS REFERENCE TO RELATED APPLICATIONS

This application is a continuation-in-part application of U.S. patent application Ser. No. 14/706,183, entitled “Method and System for Matching Graphics” and filed on May 7, 2015, which claims priority to Taiwan Patent Application No. 103116486, filed May 9, 2014, all of which are incorporated herein by reference in its entirety.

### BACKGROUND OF THE INVENTION

### Field of the Invention

The invention relates to a method and a system for matching graphics.

### Description of the Related Art

Clothing is capable of not only keeping out the cold but providing attractive appearance for people. It is a dream for many people to wear the most fashionable garments all the time.

### BRIEF SUMMARY OF THE INVENTION

The invention provides a method and a system for matching graphics, so that the above dream can come true in a virtual world.

In addition, the invention can be applied to other technical fields requiring graphic matching to provide graphics for a user via networks and associated merchants to perform graphic matching.

The method for matching graphics for an electronic device in accordance with an exemplary embodiment of the invention includes: receiving a connection of at least one merchant device via a network, wherein the merchant device is connected to a manage platform on the electronic device; receiving a plurality of first secondary object graphics from the merchant device; receiving a connection of at least one user device via a network, wherein the user device is connected to the manage platform on the electronic device; providing the first secondary object graphics for the user device; displaying the first secondary object graphics in a first display area by the user device; and when one of the first secondary object graphics is selected, enlarging and fitting the one of the first secondary object graphics on a primary object graphic so that the selected one of the first secondary object graphics enlarged and fitted on the primary object graphic is always larger than all other first secondary object graphics in the first display area.

In another exemplary embodiment, the merchant device provides a list, and the first secondary object graphics are provided for the user device when a user of the user device is in the list.

In yet another exemplary embodiment, the merchant device provides a recommended combination of the first secondary object graphics for the user device to fit the recommended combination of the first secondary object graphics on the primary object graphic.

In another exemplary embodiment, the first secondary object graphics are configured to be fitted on different portions of the primary object graphic.

In yet another exemplary embodiment, the first secondary object graphics are configured to be fitted on a portion of the primary object graphic.

In another exemplary embodiment, the primary object graphic partially overlaps the first display area.

In yet another exemplary embodiment, further comprising displaying a plurality of second secondary object graphics in a second display area by the user device.

In another exemplary embodiment, further comprising hiding the first display area and the first secondary object graphics by the user device.

In yet another exemplary embodiment, the primary object graphic partially overlaps the second display area.

In another exemplary embodiment, further comprising: receiving first barcode data corresponding to the first secondary object graphics from the merchant device; providing the first barcode data for the user device; storing the first barcode data in the user device; receiving second barcode data by the user device; comparing the second barcode data with the first barcode data by the user device; and when the second barcode data received by the user device are different from the first barcode data stored in the user device, providing a second secondary object graphic corresponding to the second barcode data for the user device.

The invention also provides a system for matching graphics. The system for matching graphics for an electronic device in accordance with an exemplary embodiment of the invention includes: a memory circuit configured to store a plurality of first secondary object graphics provided by at least one merchant device; and a processor circuit configured to execute a management platform, receive a connection of the merchant device via a network and receive a connection of at least one user device via the network, wherein the merchant device is connected to the management platform to provide the first secondary object graphics, and the user device is connected to the management platform to receive the first secondary object graphics and display the first secondary object graphics in a first display area; when one of the first secondary object graphics is selected, the selected one of the first secondary object graphics is enlarged and fitted on a primary object graphic so that the selected one of the first secondary object graphics enlarged and fitted on the primary object graphic is always larger than all other first secondary object graphics in the first display area.

In another exemplary embodiment, the merchant device provides a list, and the first secondary object graphics are provided for the user device when a user of the user device is in the list.

In yet another exemplary embodiment, the merchant device provides a recommended combination of the first secondary object graphics for the user device to fit the recommended combination of the first secondary object graphics on the primary object graphic.

In another exemplary embodiment, the first secondary object graphics are configured to be fitted on different portions of the primary object graphic.

In yet another exemplary embodiment, the first secondary object graphics are configured to be fitted on a portion of the primary object graphic.

In another exemplary embodiment, the primary object graphic partially overlaps the first display area.

In yet another exemplary embodiment, the user device further displays a plurality of second secondary object graphics in a second display area.

In another exemplary embodiment, the user device hides the first display area and the first secondary object graphics after displaying the second display area.

In yet another exemplary embodiment, the primary object graphic partially overlaps the second display area.

The invention also provides a non-transitory machine-readable storage medium. The non-transitory machine-readable storage medium including a computer program, which, when executed, causes a device to perform a method for matching graphics, wherein the method includes: receiving a plurality of secondary object graphic provided by a merchant device; providing the secondary object graphics for at least one user device; displaying the secondary object graphics in a display area by the user device; and when one of the secondary object graphics is selected, enlarging and fitting the one of the secondary object graphics on a primary object graphic so that the selected one of the secondary object graphics enlarged and fitted on the primary object graphic is always larger than all other secondary object graphics in the display area.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an embodiment of a system for matching graphics of the invention;

FIG. 2 is a block diagram of an embodiment of an electronic device executing a management platform;

FIG. 3 is a flow chart of an embodiment of a method for matching graphics of the invention;

FIG. 4 is a flow chart of another embodiment of a method for matching graphics of the invention;

FIG. 5 is a flow chart of an embodiment of receiving secondary object graphics of the invention;

FIG. 6 is a flow chart of an embodiment of matching secondary object graphics and a primary object graphic;

FIGS. 7A, 7B and 7C depict an embodiment of matching secondary object graphics and a primary object graphic; and

FIGS. 8A, 8B and 8C depict an embodiment of switching the display areas of secondary object graphics.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

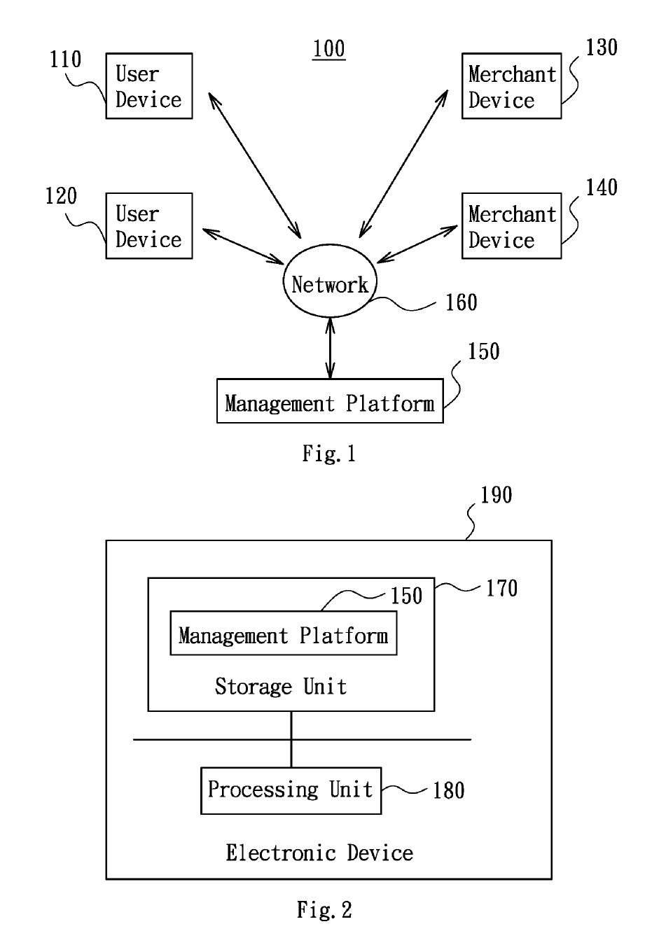

Referring to FIG. 1, a system 100 for matching graphics in accordance with the invention includes user devices 110 and 120, merchant devices 130 and 140, and a management platform 150. The merchant devices 130 and 140 may be electronic devices capable of connecting to a network, such as personal computers or mobile devices (mobile phones, smart phones, personal digital assistants, global positioning system, laptops, etc.). Merchants can respectively connect the merchant devices 130 and 140 to the management platform 150 through a network 160 such as a wired network, a telegram network or a wireless network for providing graphics. In addition, the user devices 110 and 120 may be electronic devices capable of connecting to a network, such as mobile phones, smart phones, personal digital assistants, global positioning system and laptops. Users can respectively use the user devices 110 and 120 to access the management platform 150 via the network 160.

Referring to FIG. 2, an electronic device 190 for executing a management platform of the invention includes a storage unit 70 and a processing unit 180. The storage unit 170 can temporarily or permanently store related data which include the management platform 150 executed by the processing unit 180, graphics and interfaces for user's operation (such as a user interface provided by the management platform 150), at least one primary object graphic, and at least one secondary object graphic provided by the merchant devices 130 and 140. It is noted that in some embodiments, the management platform 150 may have a classification system such as standard industry codes (SID) which are displayed in a user interface for user's operation. The electronic device 190 in which the management platform 150 is executed includes a network connecting unit (not shown in FIG. 2). The electronic device 190 is capable of connecting to a network through the network connecting unit.

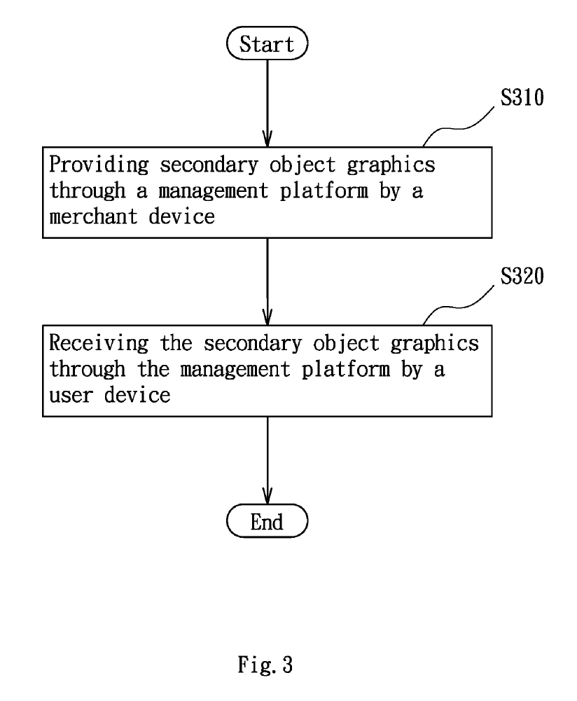

A method for matching graphics of the invention is shown in FIG. 3. In step S310, at least one of the merchant devices 130 and 140 is connected to a management platform 150 in an electronic device 190 via a network 160 and provides at least one secondary object graphic to be stored temporarily or permanently in a storage unit 170. In step S320, at least one of the user devices 110 and 120 is connected to the management platform 150 in an electronic device 190 via a network 160 and receives secondary object graphics provided by the merchant devices 130 and 140 from the storage unit 170. It is noted that in some embodiments, a user must register to become a member before authorized to use the management platform 150.

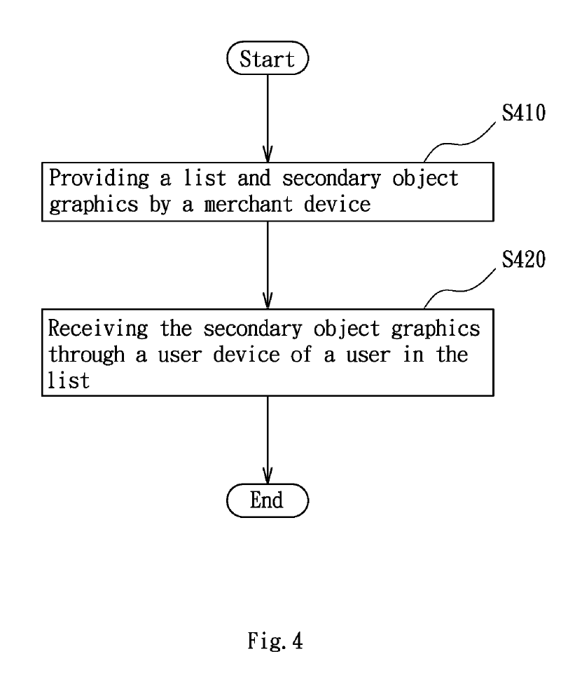

In some other embodiments, the management platform 150 allows some users of the user devices 110 and 120 to receive the secondary object graphics from the merchant devices 130 and 140 after the users are authorized by the merchants. The users, for example, are VIP of the merchants or recorded consumers. The merchants, for example, are the merchants who sell boutique clothes, and are able to provide graphics of clothes and pants of the season for the authorized users through the management platform 150. FIG. 4 shows a management method for the users to obtain the secondary object graphics. In step S410, a list and a plurality of object graphics are provided by the merchant device 130 or 140 and stored temporarily or permanently in a storage unit 170. In step S420, a user in the list can access the management platform 150 through the user device 110 or 120 via the network 160 and obtain the secondary object graphics of the merchant device 130 or 140 from the storage unit 170.

In the invention, a user can match the secondary object graphics and the primary object graphic. In some embodiments, the primary object graphic may be a graphic of a person (the user himself/herself or another person) or an animal (a pet of the user or a famous animal star), the secondary object graphics may be the graphics of clothes, pants, shoes, accessories or hats. However, the invention is not limited thereto. In some other embodiments, the primary object graphic may be a graphic of an interior space, such as a living room, a dining room, a bedroom or a bathroom, and the secondary object graphics may be the graphics of furniture, appliances, wallpaper, or sanitary equipments. In some embodiments, the primary object graphic is provided for the user devices 110 and 120 by the management platform 150 for the users to use.

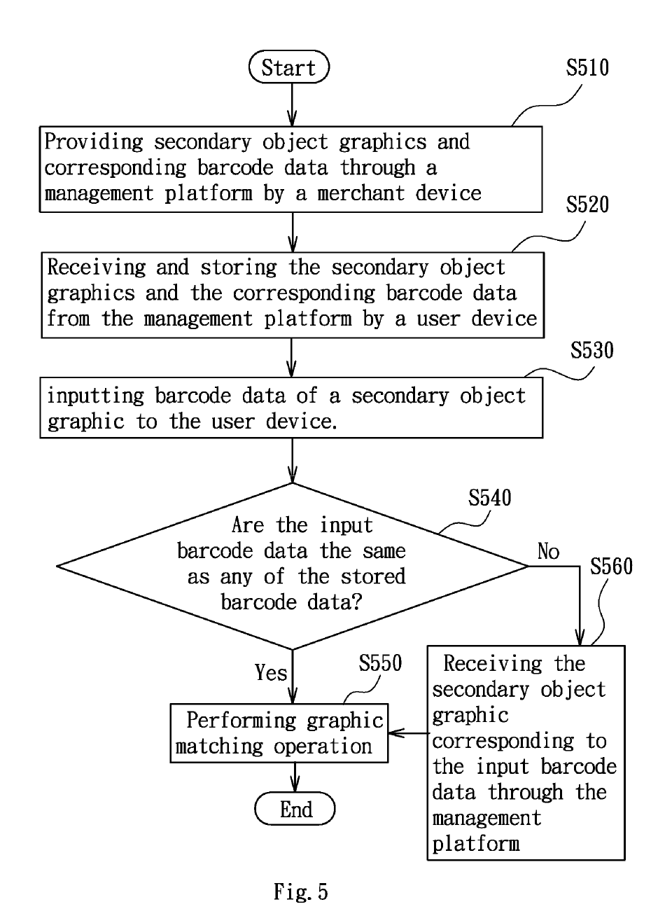

In some embodiments, the user can input barcode data to the user device for finding out secondary object graphics corresponding to the barcode data to match with the primary object graphic. Referring to FIG. 5, in step S510, the merchant devices 130 and 140 provide a plurality of secondary object graphics and barcode data corresponding to the secondary object graphics through the management platform 150. In step S520, the user device 110 or 120 receives and stores at least one secondary object graphic and barcode data corresponding to the secondary object graphics through the management platform 150. In step S530, a user inputs the barcode data of a secondary object graphic to the user device 110 or 120. The secondary object graphics may be clothing graphics shown in a print advertisement, a TV advertisement or a network advertisement. The barcode is disposed besides the clothing graphic. The user devices 110 or 120 may be a mobile phone, and the user can input the barcode by photographing it. In step S540, the input barcode data is compared with the barcode data stored in the mobile phone. If the input barcode data are the same as any of the stored barcode data, then it means that the clothing graphics are already stored in the mobile phone. The procedure enters step S550 to perform the graphic matching operation of the primary object graphic and the secondary object graphics. If the input barcode data are different from all of the stored barcode data, then it means that the clothing graphics are not stored in the mobile phone, and the procedure enters step S560 in which the user device 110 or 120 needs to receive the clothing graphics through the management platform 150 before the graphic matching operation is performed.

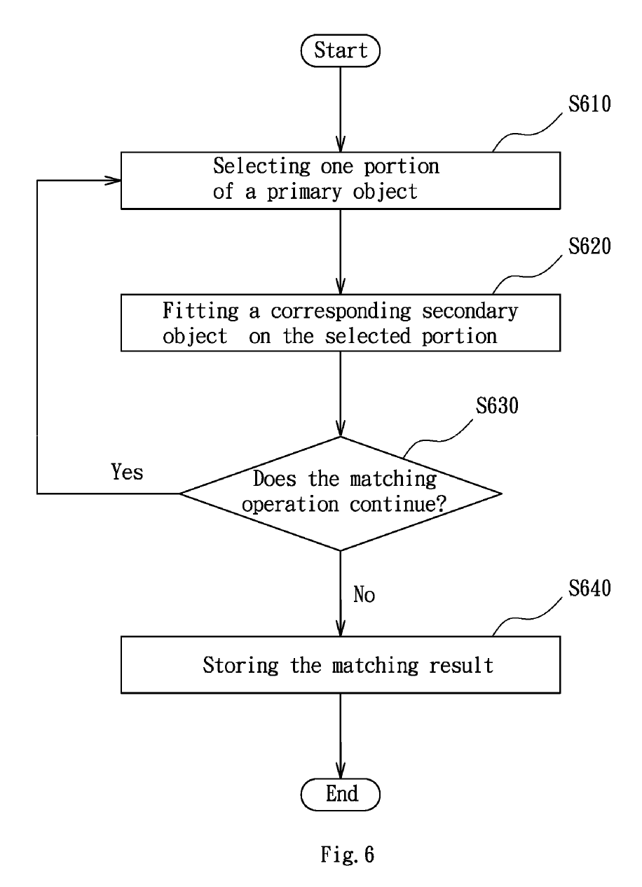

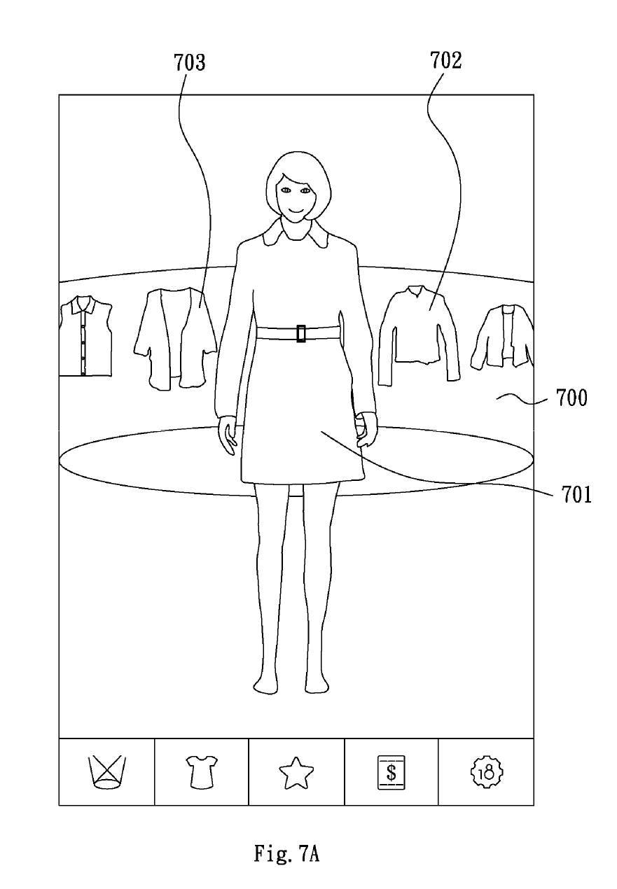

FIG. 6 shows the graphic matching method of the primary object graphics and the secondary object graphics. In step S610, a user selects a portion of a primary object graphic. In some embodiments, the primary object is the user himself/herself and the selected portion of the primary object is the head, the upper body, the lower body or the feet. In step S620, the user fits the secondary object graphics on the selected portion of the primary object. In some embodiments, when the user selects the head, the secondary object may be a hat or headwear. When the user selects the upper body, the secondary object may be underwear, a shirt, a necktie, a sleeveless garment, a woolen sweater or a coat. When the user selects the lower body, the secondary object may be pants or a skirt. When the user selects the feet, the secondary object may be shoes. It is understood that each kind of the secondary objects may have a plurality of styles for the user to select. For example, the user can select from different styles of in-season underwear graphics provided by the merchant and fit the selected underwear graphics on the upper body graphic. If the user is not satisfied with the combination, then the underwear graphic can be removed from the upper body graphic and the user can select and fit another underwear graphic on the upper body graphic. In step S630, the user determines whether the matching operation continues. If the user determines to continue the matching operation, then steps S610 and S620 are repeated, wherein the user needs to select another portion of primary object graphic for matching operation. It is noted that the user can select the same portion for matching operation. For example, the upper body is selected and underwear is fitted thereon at the first time, and the upper body can be selected again and a shirt is fitted thereon at the next time. The selected shirt graphic overlaps the selected underwear graphic, just like that the user wears the underwear first and then wears the shirt. By repeating steps S610, S620, and S630, the user can complete the matching of the primary object graphic and the secondary object graphics. If the primary object graphic is the user's picture, the user in the picture can be fully dressed through the described matching operation. In step S640, the user can store the combination of the primary object graphic and secondary object graphics for future use. For example, the user can upload the combination of the graphics and share it with friends on a personal website.

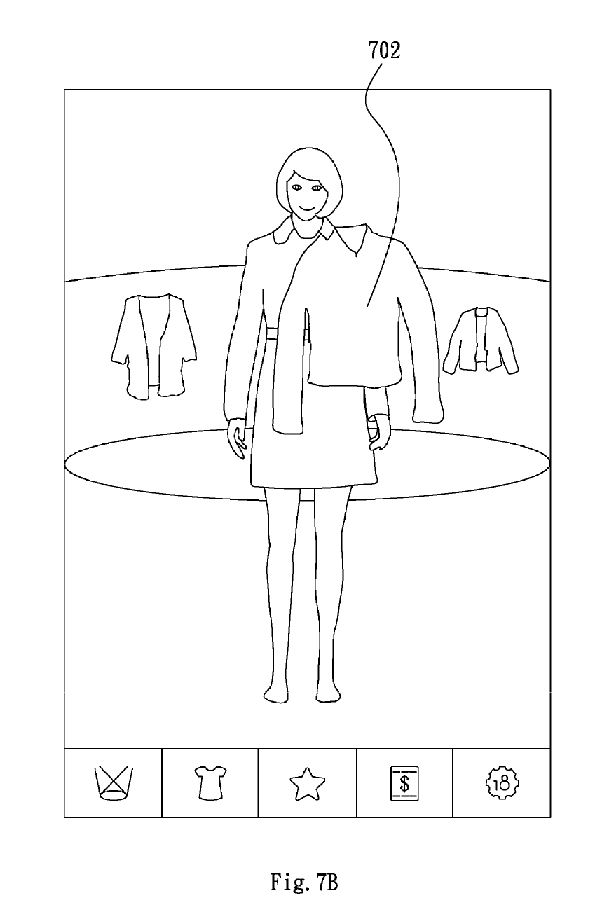

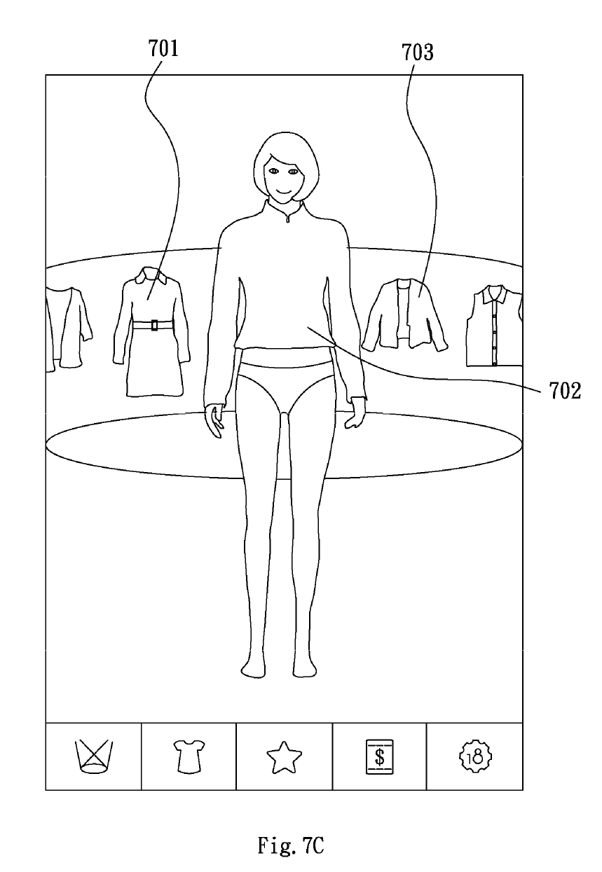

An example of matching operation is described as follows. In this example, the user devices 110 and 120 are mobile phones. FIGS. 7A to 7C depict the graphics displayed by the mobile phones, wherein the primary object is a person and the secondary objects are blouses. In operation, user's finger slides on the screen of the mobile phone for graphic matching. A display area 700 is disposed behind the person, and a plurality of blouses 702 and 703 are displayed in the display area 700. As shown in FIG. 7A, a blouse 701 has been worn by the person on her upper body. It is noted that the blouses 701 which is selected to be fitted on the person is always larger than all other unselected blouses 702 and 703 in the display area 700. If the user wants to change the blouse 701 to the blouse 702 (in other words, the blouse 702 is selected by the user), she can put her finger on the display area 700 and move her finger to the left. Then, the blouse 702 in the rear display area 700 is moved forwards and is enlarged at the same time (see FIG. 7B). The user's finger is moved until the blouse 702 is worn by the person (see FIG. 7C). The blouse 702 selected, enlarged and fitted on the person is now larger than all other unselected blouses 701 and 703 in the display area 700. In sum, any of the blouses selected, enlarged and fitted on the person is always larger than all other unselected blouses in the rear display area 700. It is understood that different blouses 701, 702, 703 can be worn by the person in turns by repeating the described operation.

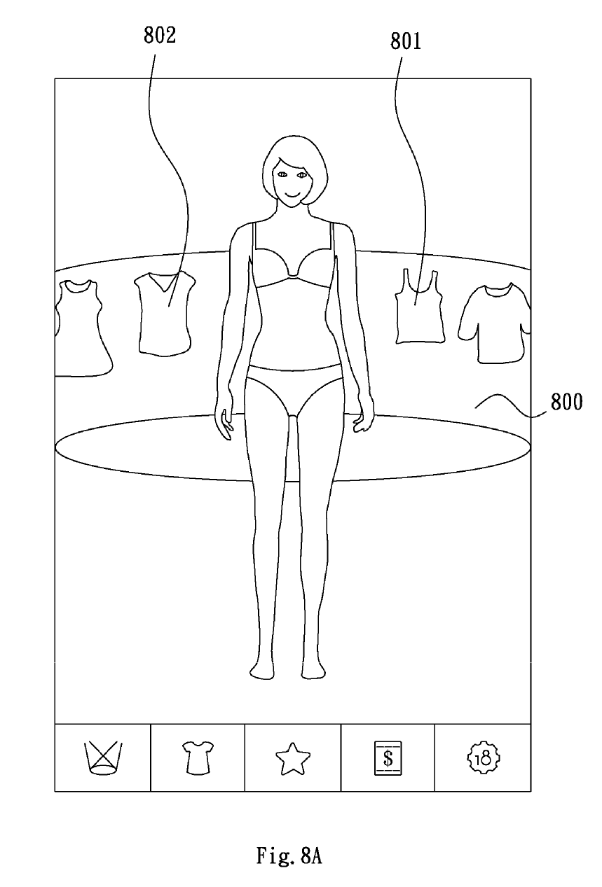

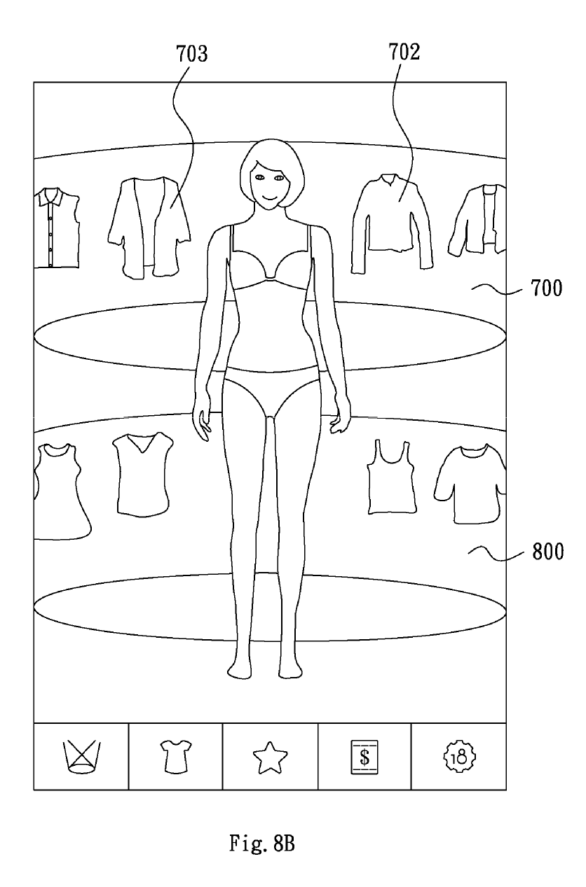

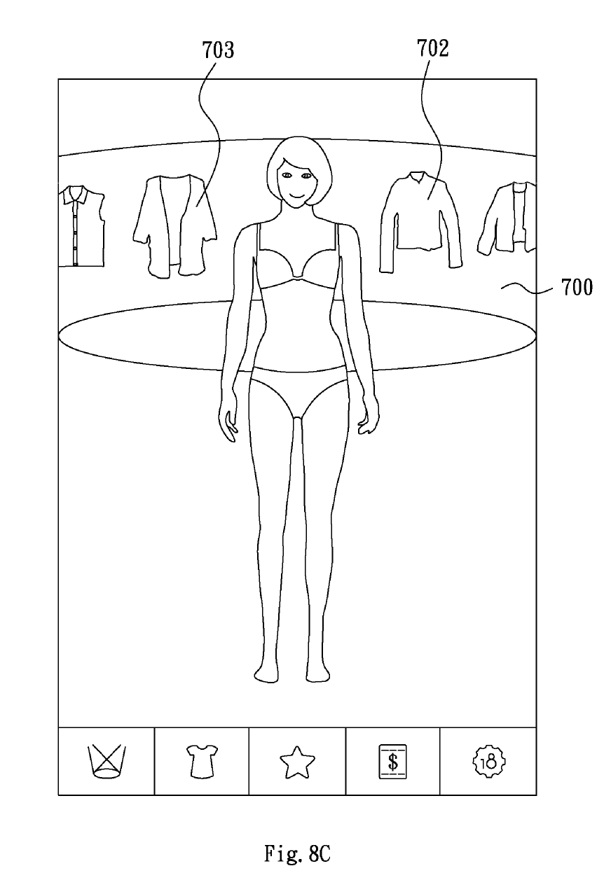

In another embodiment, different kinds of secondary object graphics are displayed in different display areas including a hat display area, a tank top display area, a blouse display area, a pants display area, a shoe display area and so on. The display areas on the screen of the mobile phone can be switched. As shown in FIG. 8A, tank top graphics 801 and 802 are displayed in the tank top display area 800. If the user wants to change from the tank top display area 800 to the blouse display area 700, then she can touch the tank top display area 800 and slide her finger downward. Then, the tank top display area 800 slide downward and the blouse display area 700 appear in the position originally occupied by the tank top display area 800. The tank top display area 800 disappears after a short time period, as shown in FIG. 8C. Then, the user can perform the matching operation to fit the blouses 702 and 703 on the person.

Similarly, the user can match pants graphics and the person graphic by touching the blouse display area and sliding her finger downward so that the pants display area appears to replace the blouse display area. In this way, different display areas can be switched and different kinds of secondary objects can be fitted on different portions of the person.

Generally, a mobile phone has a small screen which shows limited contents. To save space in a limited screen and make the graphics bigger for easy operation, the invention provides the following arrangements: different kinds of secondary object graphics are disposed in different display areas, only one display area is shown in the mobile phone in normal times, the primary object graphic overlaps a portion of the display area, and the secondary object graphic fitted on the primary object graphic is always larger than the other unselected secondary object graphics. In such arrangement, the unselected secondary object graphics can be displayed along with the secondary object graphic selected and fitted on the primary object graphic in the small screen. Therefore, the user can easily make a selection from many secondary object graphics in the small screen of the mobile phone.

In the above embodiments, the primary object graphic overlaps a portion of the display area. However, the invention is not limited thereto. On the contrary, the display area can overlap a portion of the primary object graphic that still falls into the scope of the invention.

In the above embodiments, the secondary object graphics are arranged in a circle. However, the invention is not limited thereto. It is understood that the secondary object graphics can be arranged in a line, an array, etc. that still falls into the scope of the invention.

In some embodiments, the merchant device is able to provide information corresponding to the secondary object graphics for the user. For example, the brand, the price and manufacturing location of a blouse can be shown immediately if the blouse (the secondary object graphic) is selected by the user.

In some embodiments, the merchant can recommend a combination of a blouse and pants, which are selected by the merchant in advance, and provide the graphics of the combination of the blouse and pants for the user device 110 and 120 through the management platform 150. Therefore, the user can try on the recommended combination of the blouse and pants in accordance with the described matching operation.

In the above embodiments, the secondary object graphics can be changed. However, it is understood that the primary object graphic can be also changed. In some embodiments, the primary object can be changed from the user himself/herself to another person, for performing another matching operation in accordance with steps S610, S620, S630 and S640.

The management platform 150 can provide different background graphics for the user to match the primary object graphic and the secondary object graphics and save the matched primary object graphic and secondary object graphics for future use. In some embodiments, the background may be an interior space or an outdoor scene.

The described operation of the user devices 110 and 120, which includes fitting the secondary object graphics on the primary object graphic, removing the secondary object graphics from the primary object graphic, changing the primary object graphics, changing the secondary object graphics and changing the background graphics, can be performed by various input devices such as a touch screen, a mouse, a keyboard, and an optical pen.

In the above embodiments, the graphic matching operation of the invention is manually performed by the user. However, the invention is not limited thereto. It is understood that the matching operation can be automatically displayed by computer programs in a manner that the secondary object graphics are alternately fitted on the primary object graphic.

Methods for information distribution, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for matching graphics for an electronic device, comprising:
receiving a connection of at least one merchant device via a network, wherein the merchant device is connected to a manage platform on the electronic device;
receiving a plurality of first secondary object graphics from the merchant device;
receiving a connection of at least one user device via a network, wherein the user device is connected to the manage platform on the electronic device;
providing the first secondary object graphics for the user device;
displaying the first secondary object graphics in a first display area by the user device; and
when one of the first secondary object graphics is selected, enlarging and fitting the one of the first secondary object graphics on a primary object graphic so that the selected one of the first secondary object graphics enlarged and fitted on the primary object graphic is always larger than all other first secondary object graphics in the first display area.

2. The method as claimed in claim 1, wherein the merchant device provides a list, and the first secondary object graphics are provided for the user device when a user of the user device is in the list.

3. The method as claimed in claim 1, wherein the merchant device provides a recommended combination of the first secondary object graphics for the user device to fit the recommended combination of the first secondary object graphics on the primary object graphic.

4. The method as claimed in claim 1, wherein the first secondary object graphics are configured to be fitted on different portions of the primary object graphic.

5. The method as claimed in claim 1, wherein the first secondary object graphics are configured to be fitted on a portion of the primary object graphic.

6. The method as claimed in claim 1, wherein the primary object graphic partially overlaps the first display area.

7. The method as claimed in claim 1, further comprising displaying a plurality of second secondary object graphics in a second display area by the user device.

8. The method as claimed in claim 7, further comprising hiding the first display area and the first secondary object graphics by the user device.

9. The method as claimed in claim 8, wherein the primary object graphic partially overlaps the second display area.

10. The method as claimed in claim 1, further comprising:
receiving first barcode data corresponding to the first secondary object graphics from the merchant device;
providing the first barcode data for the user device;
storing the first barcode data in the user device;
receiving second barcode data by the user device;
comparing the second barcode data with the first barcode data by the user device; and
when the second barcode data received by the user device are different from the first barcode data stored in the user device, providing a second secondary object graphic corresponding to the second barcode data for the user device.

11. A system for matching graphics for an electronic device, comprising:
a memory circuit configured to store a plurality of first secondary object graphics provided by at least one merchant device; and
a processor circuit configured to execute a management platform, receive a connection of the merchant device via a network and receive a connection of at least one user device via the network, wherein the merchant device is connected to the management platform to provide the first secondary object graphics, and the user device is connected to the management platform to receive the first secondary object graphics and display the first secondary object graphics in a first display area;
when one of the first secondary object graphics is selected, the selected one of the first secondary object graphics is enlarged and fitted on a primary object graphic so that the selected one of the first secondary object graphics enlarged and fitted on the primary object graphic is always larger than all other first secondary object graphics in the first display area.

12. The system as claimed in claim 11, wherein the merchant device provides a list, and the first secondary object graphics are provided for the user device when a user of the user device is in the list.

13. The system as claimed in claim 11, wherein the merchant device provides a recommended combination of the first secondary object graphics for the user device to fit the recommended combination of the first secondary object graphics on the primary object graphic.

14. The system as claimed in claim 11, wherein the first secondary object graphics are configured to be fitted on different portions of the primary object graphic.

15. The system as claimed in claim 11, wherein the first secondary object graphics are configured to be fitted on a portion of the primary object graphic.

16. The system as claimed in claim 11, wherein the primary object graphic partially overlaps the first display area.

17. The system as claimed in claim 11, wherein the user device further displays a plurality of second secondary object graphics in a second display area.

18. The system as claimed in claim 17, wherein the user device hides the first display area and the first secondary object graphics after displaying the second display area.

19. The system as claimed in claim 18, wherein the primary object graphic partially overlaps the second display area.

20. A non-transitory machine-readable storage medium comprising a computer program, which, when executed, causes a device to perform a method for matching graphics, wherein the method comprises:
receiving a plurality of secondary object graphics provided by a merchant device;
providing the secondary object graphics for at least one user device;
displaying the secondary object graphics in a display area by the user device; and
when one of the secondary object graphics is selected, enlarging and fitting the one of the secondary object graphics on a primary object graphic so that the selected one of the secondary object graphics enlarged and fitted on the primary object graphic is always larger than all other secondary object graphics in the display area.
